(19) United States
(12) Patent Application Publication
(10) Pub. No.: US 2006/0180551 A1
(43) Pub. Date: Aug. 17, 2006

(54) Polyacrylamide water clarifier

(76) Inventors: Richard C. Beckman III, (US); William J. Lorenzo, (US)

Correspondence Address: MILES & STOCKBRIDGE PC, 1751 PINNACLE DRIVE, SUITE 500, MCLEAN, VA, 22102-3833, US

(21) Appl. No.: 10/460,668

(22) Filed: Jun. 13, 2003

(51) Int. Cl. C02F 1/52

(52) U.S. Cl. 210/733; 210/206

(57) ABSTRACT

A liquid clarifier provided with at least one solid mass of polyacrylamide, comprising a housing having an inner space, a liquid inlet and a liquid outlet, the at least one solid mass being accommodated in the housing inner space such as to divide the inner space into a liquid inlet side space communicating with the liquid inlet, a liquid to be clarified being introduced into the liquid inlet side space from the liquid inlet, and a liquid outlet side space communicating with the liquid outlet, a clarified liquid being accommodated in the liquid outlet side space and discharged from the liquid outlet.

### BACKGROUND OF THE INVENTION

1. Field of the Invention

The invention relates to systems and methods for water clarification and purification.

2. Description of the Prior Art

The present invention relates to an improved system for removing turbidity-causing impurities from surface waters and other domestic and industrial water supplies containing such impurities.

Turbid water has a haziness caused by insoluble, suspended particles such as clay, silt, bacteria, viruses, organic debris resulting from the decay of plant life and similar materials present in the water. Turbidity standards have been established by governmental regulatory authorities for determining the water quality of municipal distribution facilities. With certain limited exceptions, a monthly average of one turbidity unit (TU) has been set as the maximum contaminant limit for turbidity. Turbidity measurements are made by determining the amount of light that is scattered by particulate matter in a sample of water.

Although water treatment for turbidity removal may vary depending on raw water quality, conventional systems generally involve pre-treatment including coagulation/flocculation and sedimentation, followed by filtration and chlorination.

Coagulation is ordinarily carried out in a rapid mixing tank by adding to the raw water a chemical agent which causes agglomeration of the suspended matter into larger particles that can settle to the bottom of a containment means. The agglomerated particles, or floc, are sometimes subjected to gentle agitation in order to form floe bundles large enough to settle rapidly. A separate flocculation tank is often provided for this purpose.

Sedimentation is the process by which floe is separated from water by precipitation and deposition, and depends on the effect of gravity on particles suspended in a liquid of lesser density. Sedimentation without pre-treatment is rarely adequate for clarification of turbid water, as it does very little for removal of such fine particulate substances as clay, bacteria and the like. Also, sedimentation results in sludge formation and thus requires means for disposal of the sludge.

After the impure water undergoes appropriate pre-treatment, it is clarified for the removal of suspended particles by passage through a porous medium. Most conventional water treatment systems employ granular media filtration. For example, rapid sand clarifiers and mixed media clarifiers (e.g. sand and particulate coal) have proved effective for reducing turbidity. However, granular media filtration virtually always requires chemical pre-treatment for effective turbidity removal. Slow sand clarifiers, which were among the first water treatment systems to be used for large scale filtration, have numerous shortcomings when it comes to treating turbid water, including low filtration capacity, channeling, and ease of clogging.

The cost of the space and equipment required for installation of a conventional water treatment system of the type described above is considerable, as is the continuing cost of operation and maintenance of such a system. Although efforts toward improving these prior art processes have continued, the improvements have related in general to enhancing floe formation and sedimentation, reducing the load on the clarifiers, and using larger grained sand and higher filtration rates as a means of reducing cost.

Alternative municipal water treatment processes employing clarifier-aid principles have been developed more recently to reduce the requirements for large and expensive vessels to provide for floe formation and sedimentation. These systems are commonly known as precoat filtration systems and consist essentially of a pressure vessel containing a porous septum which is coated on the upstream side with a powdered clarifier medium which forms the precoat clarifier cake. As water flows through the cake, the solid impurities present in the water are caught in the cake's small pores. In this system, additional clarifier aid is normally added to the body of the raw water in an amount sufficient for efficient and effective turbidity removal, the added clarifier aid being referred to as a body feed. The amount of body feed must be such as to prevent clarifier blinding and waste of precoat material resulting from short periods of operation. In general, optimum results are obtained using about 0.8% to 1.0% of body feed by weight, in accordance with the manufacturers' recommendations. The most widely used of the precoat clarifiers is the diatomaceous earth clarifier.

It has been reported that effective clarification and purification of turbid water may be achieved by precoat filtration, using relatively small amounts of diatomaceous earth as body feed, provided that chemical additives, namely flocculating agents and polyelectrolytes, are added to the raw water with the body feed. See, U.S. Pat. No. 3,227,650. Apparently, the use of polyelectrolytes in this patented process is essential, for if a flocculating agent alone is used in conjunction with the diatomaceous earth, the water is practically unclarifiable. Further, it has been found that if diatomaceous earth alone is used as the precoat and body feed, the filtrate, while reduced in turbidity, is unacceptable for potable or industrial use.

While recent developments in the art have eliminated some of the cost of installation and equipment maintenance, the overall operating cost of municipal water treatment remains relatively high. In short, the cost of water treatment, whether by conventional systems or by systems operating on the clarifier aid principle, makes it uneconomic for many smaller applications. Hence, the development of an efficient and effective process for clarifying water at a reasonable cost continues to be a highly desired objective.

### SUMMARY OF THE INVENTION

One embodiment of the invention relates to a novel liquid clarifier for removing insoluble materials from a liquid, the clarifier having upstream and downstream sides and comprising at least one mass of solid polyacrylamide.

An additional embodiment of the invention is a liquid clarifier provided with at least one mass of solid polyacrylamide, comprising a housing having an inner space, a liquid inlet and a liquid outlet, the at least one mass being accommodated in the housing inner space such as to divide the inner space into a liquid inlet side space communicating with the liquid inlet, a liquid to be clarified being introduced into the liquid inlet side space from the liquid inlet, and a liquid outlet side space communicating with the liquid outlet, a clarified liquid being accommodated in the liquid outlet side space and discharged from the liquid outlet.

The invention also provides improved methods of clarifying a liquid to remove undesirable impurities therefrom, the improvements comprising employing, as a clarifier, one of the above described embodiments.

An additional embodiment of the invention provides the use of polyacrylamide to manufacture the above-described embodiments of clarifier useful for the removal of unwanted impurities from a liquid.

A further embodiment of the invention concerns an article of manufacture comprising packaging material and a mass of solid polyacrylamide contained within the packaging material, wherein the polyacrylamide is effective for the clarification of a liquid, and wherein the packaging material comprises a label which indicates that the polyacrylamide can be used for the clarification of a liquid and the mass of solid polyacrylamide resides in a container that permits contact between the liquid and the solid polyacrylamide upon contact between the container and the liquid to be clarified.

An additional embodiment of the invention relates to a kit comprising a plurality of masses of solid polyacrylamide, each adapted for contact with a flow of liquid requiring clarification.

### BRIEF DESCRIPTION OF THE DRAWINGS

FIG. 1 is a side elevational view of a system according to the invention.

FIG. 2 is a front elevational view of the system of FIG. 1.

FIG. 3 is a rear elevational view of the system of FIG. 1.

FIG. 4 is a top elevational view of the system of FIG. 1.

FIG. 5 is a cross section view of FIG. 1

FIG. 6 is a cross section view of FIG. 2.

### DETAILED DESCRIPTION OF THE INVENTION

The present invention is predicated on the discovery that a mass of polyacrylamide is an excellent and very efficient water clarifier material or medium, particularly in the case of clarifying particulate matter from aqueous media.

Polyacrylamide has long been known to be useful as a flocculent or coagulant in liquid purification systems and methods. Human intervention for the intentional coagulation of impurities in water to aid in their removal is reported as early as 2000 BC by Romans and Egyptians using alum (Faust and Aly, 1998). Pliny, 77AD, reported the use of a mixture of lime and alum for water clarification. Alum became an important item of trade in these early years mainly for leather treatment and as a dye mordant. By 1757, muddy water was being clarified in the UK using alum followed by filtration of the supernatant.

Aluminum and ferric salts have dominated the inorganic coagulant market due to their inherent hydrolysis yielding highly cationic oligomers. Intentionally prepolymerized versions, polyaluminum chloride (PAC) and polyferric sulfate (PFS) are important developments from the simple salts and were patented in Japan in 1972 and 1976 respectfully. Both have the advantage of being less pH dependent than their simple salts.

The use of lime in mineral processing is a panacea. It coagulates, depresses iron sulfides, keeps cyanide in solution and caustisizes by removing carbonate ions. Early hard rock base metal tailings relied on lime as the coagulant during thickening and the early thickener sizing methods were developed using limed pulps.

Whereas inorganic salts promote coagulation by charge neutralization and double-layer compression, organic polymers promote solid-liquid separation by the bridging mechanism sometimes in combination with charge patch effects.

Polymers derived from plant-based materials were the first flocculants. Sanskrit writings in India dating from several centuries BC make reference to seeds of the Nirmali nut tree, Strychnos potatorum, as a clarifier. Peruvian texts from the 16th and 17th Centuries describe the use by sailors of powdered, roasted grains of Zea mays (corn starch) as a means of settling impurities. More recently, Chilean folklore texts from the 19^{th} Century refer to water clarification using the sap from the ‘tuna’ cactus (Opuntiafiscus indica). Isinglass, produced from fish swim bladders, has been used as finings for centuries for clarifying beer. The principal reactive constituent of isinglass is collagen. Collagen is a unique molecule that exists as a triple helix with three chains of amino acids wound around each other and held in place by complex hydrogen bonding. It is amphoteric but functions as a cationic polymer when removing yeast particles.

Naturally derived polymers that were used extensively as flocculants in mineral processing included animal glue, gelatin, starch and guar gum. Glue and gelatin are derived from collagen-bearing materials like bones and hides; they were used extensively in acidic hydrometallurgical operations like uranium extraction and were particularly effective at removing colloidal silica. Both starch and guar remain in niche applications, the former in alkaline environments like the Bayer Process and the latter in acidic operations like uranium filtration. Both starch and guar find application as flotation depressants.

The major limitation to the performance of naturally derived flocculants is their ceiling in molecular weight or effective chain length. For gelatin/glue the maximum is approximately 300,000, for guar approximately 250,000 and amylose starch 65,000 although amylopectin fractions are higher. Potato and tapioca starches have higher molecular weights than cornstarch.

A major advancement was seen in the 1950s when polyacrylamide flocculants were introduced. Early reference is made to application in water treatment in 1958 and they were certainly being used in the mineral processing industry in the early 1960s.

The polyacrylamide molecule could be tailored to virtually every mineral processing situation and the next four decades saw massive expansion in its use. By functional substitution to the polyacrylamide chain, the addition of cationic and anionic polyelectrolytes covered all slurry environments from mono-mineralic to multimineralic, low to high suspended solids, low to high dissolved solids and low to high pH. Manipulation of molecular weight from 5 million to 25 million allowed successful application to be made on all solid-liquid separation equipment, clarifiers, thickeners, clarifiers of all types and centrifuges. Along with the polyamine and poIyDADMAC primary coagulants, polyacrylamide-based flocculants account for over 90% of the mineral processing flocculent market.

Solid-liquid separation equipment, separation science and flocculants have shown parallel development. Notable synergy is seen between high molecular weight flocculants and high rate thickeners, especially with the development of addition of dilution water to feedwells allowing the most to be made of the powerful polymers.

Typically, polyacrylamide in powder form is added to a flow of water containing sediment or other undesirable impurities. The polyacrylamide operates to flocculate or coagulate the impurities which then settle out by gravity from the flowing water or are removed employing some sort of porous clarifier.

The present invention provides a more efficient means for contacting the impure liquid with polyacrylamide for removal therefrom of the undesirable impurities.

The present invention, in its preferred embodiment, comprises a clarifier system, preferably portable, which is easily installed where needed to clarify a stream or body of water. The preferred clarifier comprises a lightweight housing having an impure water inlet side and a clarified water outlet side. If suitable, the system is located such that a stream of water to be clarified enters the inlet side of its own force and emerges in a clarified state from the outlet side. If it is desired to clarify a relatively motionless body of water, the system also comprises a pump or other device for forcing the water into the inlet side and out of the outlet side.

The invention will be described below with reference to the drawings for a preferred embodiment. It is to be understood that while a certain form of the invention is illustrated, it is not to be limited to the specific form or arrangement of parts herein described and shown. It will be apparent to those skilled in the art that various changes may be made without departing from the scope of the invention and the invention is not to be considered limited to what is shown in the drawings and described in the specification.

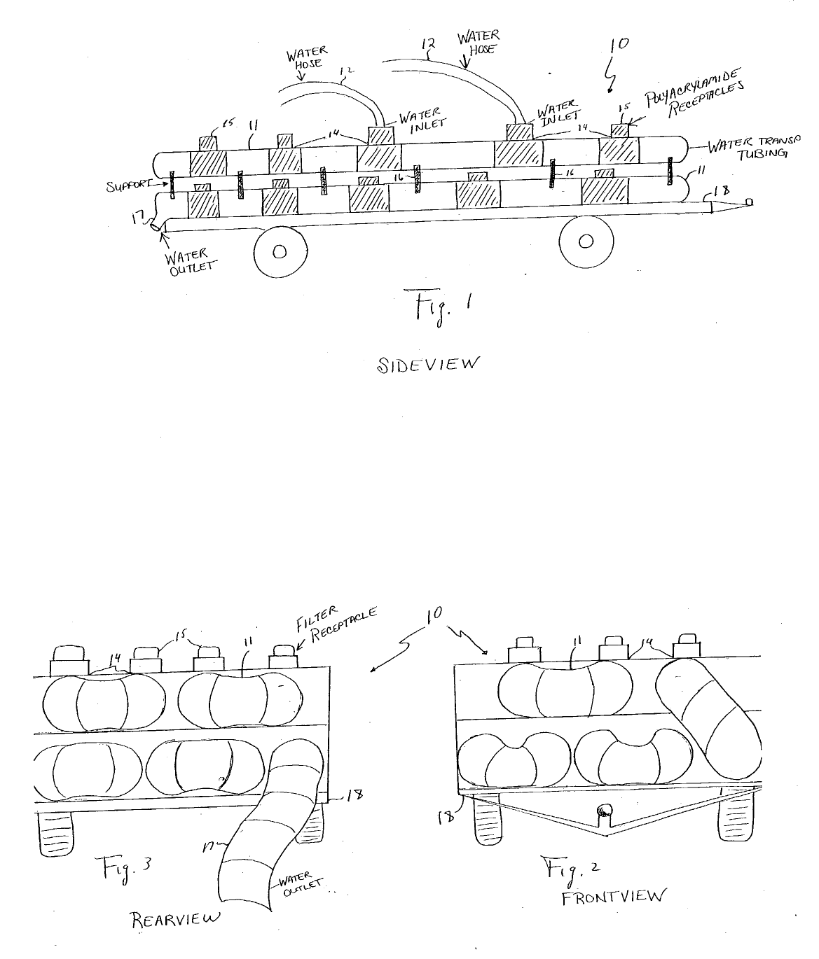

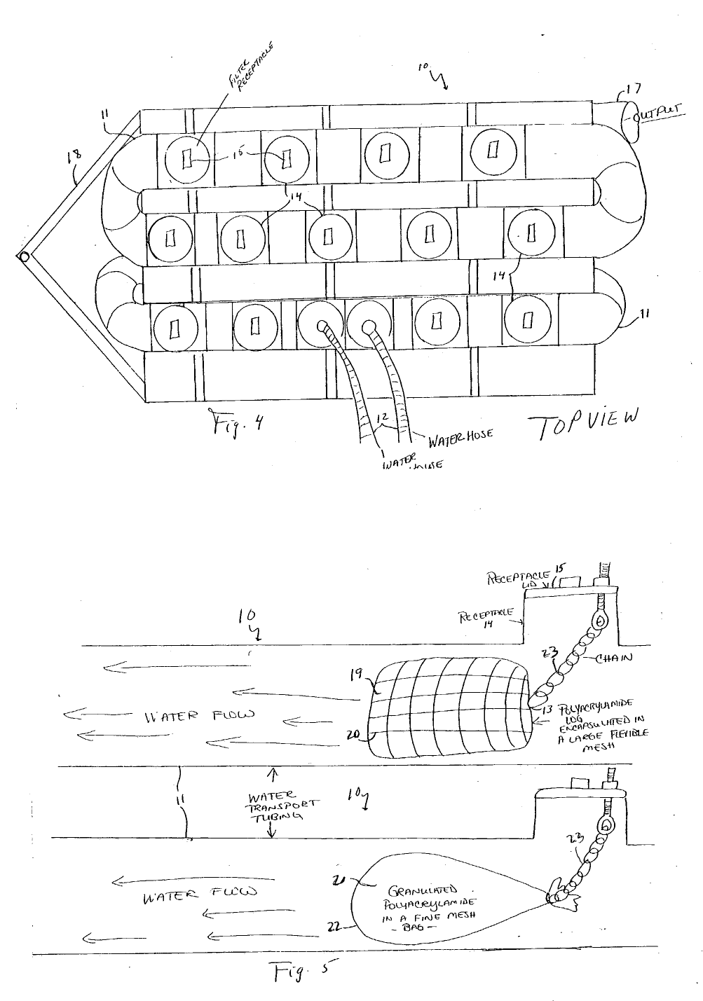

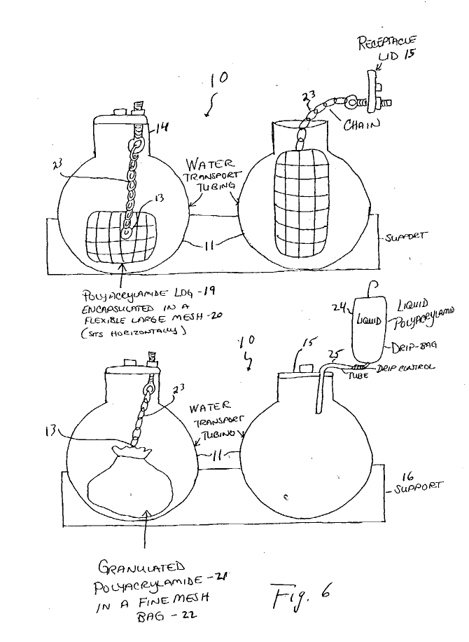

A preferred application of the invention comprises the clarification of a body, e.g., a pond of turbid water that has collected as a result of run-off from, e.g., a construction site. Referring to FIGS. 1-6, the clarification system 10 comprises a series of interconnected tubes 11 for housing turbid or impure water that enters the system via inlet hoses 12 (it being understood that one or more than two inlet hoses may also be employed). In the embodiment shown, the water enters the system as a result of being pumped from a turbid pond (not shown) by a pump (also not shown). It will be understood by those skilled in the art that a pump would not be required if the body of water to be clarified comprised a stream of turbid water that, of its own force, could enter and exit the system of the invention. The tubes 11 are connected such that the turbid water entering the system must traverse substantially the full extent of the tube system wherein it contacts solid polyacrylamide (PAM). In one embodiment, the solid PAM may comprise a log or block 19 of solid PAM encased in a large mesh flexible bag 20 or granulated or particulate PAM 21, encased in a fine mesh flexible bag 22. The PAM masses are of a size and positioned such that the water traversing the system of tubes must contact and flow around the blocks creating sufficient turbulence that the PAM enters into solution or suspension in the stream of water thereby enabling flocculation or agglomeration of the fine particles of insoluble matter that comprises the turbidity therein.

The masses of PAM are inserted into the tube system at various stations 14 through ports or lids 15. The latter are conveniently provided with chains or tethers 23 also attached to the masses of PAM at 13 such that, when opened, the ports automatically extract and reveal the masses of PAM (as depicted in FIG. 6) for replacement or other operations. In some cases, where extremely turbid waters are encountered, the system may be provided with ports 15 configured with a receptacle 24 containing a solution of PAM for metering, dripwise, e.g., into the flow of water via drip control tube 25. The extra turbidity flocculated by the solution of PAM injected into the flowstream is collected along with that flocculated by contact with the masses of PAM downstream thereof.

Where the system comprises the preferred series of interconnected superposed tubes as shown in the drawings the stacked configuration is supported by struts 16, although it will be understood by those skilled in the art that the tubes may be interconnected according to any configuration that ensures contact therein by the turbid water with the PAM masses under conditions whereby the PAM is slowly dissolved or suspended in the flowing water to enable flocculation of the impurities. The water flow containing suspended PAM agglomerates or floes of impurities exits the system via outlet 17. The effluent may be emptied via the outlet 17 to a trench (not shown) wherein the agglomerated impurities settle out of the effluent by gravity and the thus clarified water transported elsewhere, e.g., back to its origination point, in a suitably useful form. It will be understood by those skilled in the art that the effluent from the system of the invention may be conveyed to any suitable destination, such as, for example, a tank or other type of container wherein the flocculated sediment may be conveniently removed therefrom.

The system is shown as supported by trailer 18 in a portable embodiment thereof. It will also be understood by those skilled in the art that the system of the invention may comprise a more permanent, non-portable embodiment.

1. A liquid clarifier for removing insoluble materials from a liquid, said clarifier having upstream and downstream sides, and comprising at least one mass of solid polyacrylamide.

2. The clarifier of claim 3 wherein said liquid is aqueous.

3. A liquid clarifier provided with at least one mass of solid polyacrylamide, comprising a housing having an inner space, a liquid inlet and a liquid outlet, said at least one mass being accommodated in said housing inner space such as to divide said inner space into a liquid inlet side space communicating with said liquid inlet, a liquid to be clarified being introduced into said liquid inlet side space from said liquid inlet, and a liquid outlet side space communicating with said liquid outlet, a clarified liquid being accommodated in said liquid outlet side space and discharged from said liquid outlet.

4. The clarifier of claim 3 wherein said mass of polyacrylamide divides said inner space such that said liquid may pass from said liquid inlet side space to said liquid outlet side space while in contact with at least one surface of said at least one solid mass.

5. The clarifier of claim 4 wherein said inner space is divided such that said liquid, when passing in contact with said mass causes sufficient turbulence to result in dissolution or suspension of part of the polyacrylamide in said liquid.

6. The clarifier of claim 3 wherein said liquid is aqueous.

7. A portable clarifier according to claim 5.

8. A liquid clarifier provided with at least one mass of solid polyacrylamide, comprising a housing having an inner space, a liquid inlet and a liquid outlet, said at least one mass being accommodated in said housing inner space such as to divide said inner space into a liquid inlet side space communicating with said liquid inlet, a liquid to be clarified being introduced into said liquid inlet side space from said liquid inlet, and a liquid outlet side space communicating with said liquid outlet, a clarified liquid being accommodated in said liquid outlet side space and discharged from said liquid outlet, wherein at least one of said at least one mass of solid polyacrylamide is a unitary solid.

9. A liquid clarifier provided with at least one mass of solid polyacrylamide, comprising a housing having an inner space, a liquid inlet and a liquid outlet, said at least one mass being accommodated in said housing inner space such as to divide said inner space into a liquid inlet side space communicating with said liquid inlet, a liquid to be clarified being introduced into said liquid inlet side space from said liquid inlet, and a liquid outlet side space communicating with said liquid outlet, a clarified liquid being accommodated in said liquid outlet side space and discharged from said liquid outlet, wherein at least one of said at least one mass of solid polyacrylamide comprises particulate polyacrylamide.

10. The clarifier of claim 8 or 9 wherein said at least one polyacrylamide mass resides in a container that permits contact between the polyacrylamide and said liquid.

11. The clarifier of claim 3 also including means for metering a solution of polyacrylamide into said liquid.

12. The clarifier of claim 3 adapted such that said liquid traverses from said inlet to said outlet.

13. The clarifier of claim 12 also comprising means to impel said traversal of said liquid from said inlet to said outlet.

14. The clarifier of claim 13 wherein said impelling means is a pump.

15. In a method of clarifying a liquid to remove undesirable impurities therefrom, the improvement comprising employing the clarifier of claim 1.

16. The method of claim 15 wherein said liquid is aqueous.

17. In a method of clarifying a liquid to remove undesirable impurities therefrom, the improvement comprising employing the clarifier of claim 5.

18. The method of claim 17 wherein said liquid is aqueous.

19. Use of polyacrylamide to manufacture the clarifier of claim 5 useful for the removal of unwanted impurities from a liquid.

20. The use of claim 19 wherein said liquid is aqueous.

21. An article of manufacture comprising packaging material and a mass of solid polyacrylamide contained within said packaging material, wherein said polyacrylamide is effective for the clarification of a liquid, and wherein said packaging material comprises a label which indicates that said polyacrylamide can be used for the clarification of a liquid and said mass of solid polyacrylamide resides in a container that permits contact between the liquid and the solid polyacrylamide upon contact between the container and the liquid to be clarified.

22. The article of claim 21 wherein said mass of polyacrylamide is a unitary solid and said container is a flexible mesh bag.

23. The article of claim 21 wherein said mass of polyacrylamide is a particulate solid and said container is a flexible mesh bag.

24. A kit comprising a plurality of masses of solid polyacrylamide, each adapted for contact with a flow of liquid requiring clarification.

25. A kit of claim 24 wherein at least one of said masses of solid polyacrylamide is a unitary solid.

26. A kit according to claim 24 wherein at least one of said masses of solid polyacrylamide is particulate.

27. A kit according to claim 24 also including at least one solution of polyacrylamide adapted for metering into said flow of liquid.
